(19) United States
(12) Patent Application Publication
(10) Pub. No.: US 2011/0080352 A1
(43) Pub. Date: Apr. 7, 2011

(54) SYSTEMS AND METHODS FOR PROVIDING AN ENHANCED KEYPAD

(76) Inventor: Yeonchul Kim, Lynnwood, WA (US)

(21) Appl. No.: 12/634,982

(22) Filed: Dec. 10, 2009

Related U.S. Application Data
(60) Provisional application No. 61/249,355, filed on Oct. 7, 2009.
(60) Provisional application No. 61/260,398, filed on Nov. 11, 2009.

(51) Int. Cl. G06F 3/041

(52) U.S. Cl. 345/173

(57) ABSTRACT

This invention relates generally to software and devices, and more specifically, to systems and methods for providing an enhanced keypad. In one embodiment, the invention includes a method including operations of establishing a character set by assigning characters of the character set to character buttons configured to being reassigned different characters for a different character set; receiving one or more input selections; determining whether the one or more input selections is from a character button; and if the one or more input selections is from a character button, identifying a character assigned to the character button.

### PRIORITY CLAIM

This application claims the benefit of U.S. provisional patent application Ser. No. 61/249,355 filed Oct. 7, 2009 (our ref. YKIM-1-1003) and U.S. provisional patent application Ser. No. 61/260,398 filed Nov. 11, 2009 (our ref. YKIM-1-1003-1). The foregoing applications are incorporated by reference in their entirety as if fully set forth herein.

### FIELD OF THE INVENTION

This invention relates generally to software and devices, and more specifically, to systems and methods for providing an enhanced keypad.

### SUMMARY

This invention relates generally to software and devices, and more specifically, to systems and methods for providing an enhanced keypad. In one embodiment, the invention includes a method including operations of establishing a character set by assigning characters of the character set to character buttons configured to being reassigned different characters for a different character set; receiving one or more input selections; determining whether the one or more input selections is from a character button; and if the one or more input selections is from a character button, identifying a character assigned to the character button.

### BRIEF DESCRIPTION OF THE DRAWINGS

Embodiments of the present invention are described in detail below with reference to the following drawings:

FIG. 1 is a block diagram of a method, in accordance with an embodiment of the invention;

FIG. 2 is a table, in accordance with an embodiment of the invention;

FIG. 3 is a table, in accordance with an embodiment of the invention;

FIG. 4 is a device interface, in accordance with an embodiment of the invention;

FIG. 5 is a device interface, in accordance with an embodiment of the invention;

FIG. 6 is a table, in accordance with an embodiment of the invention;

FIG. 7 is a table, in accordance with an embodiment of the invention;

FIG. 8 is a device interface, in accordance with an embodiment of the invention;

FIG. 9 is a component diagram of a device, in accordance with an embodiment of the invention;

FIG. 10 is a circuit diagram, in accordance with an embodiment of the invention; and

FIG. 11 is a table of values for input selections, in accordance with an embodiment of the invention.

### DETAILED DESCRIPTION

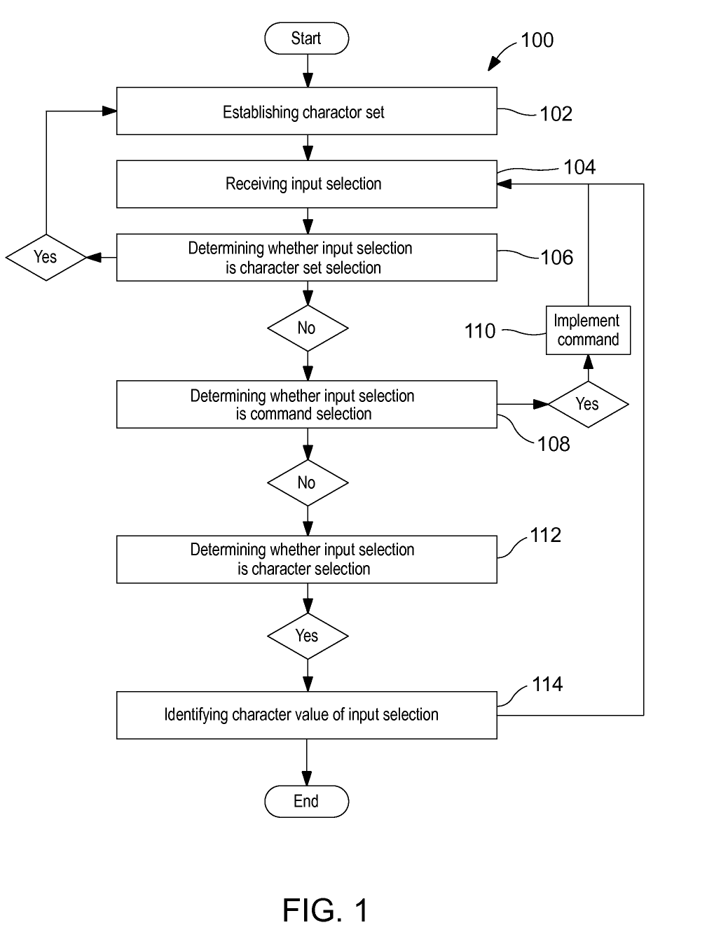

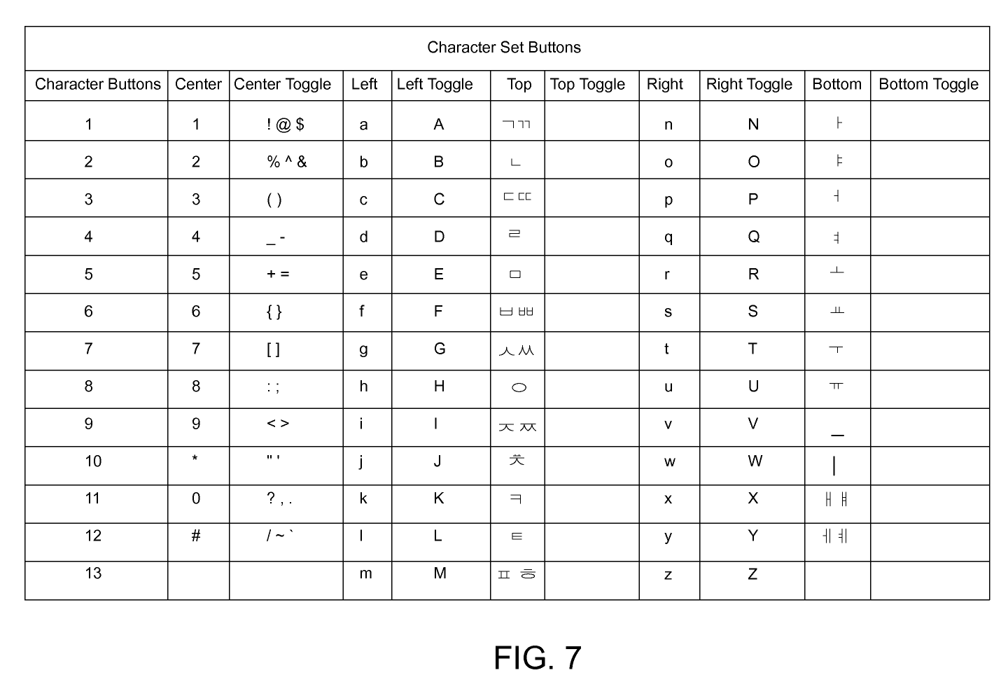

This invention relates generally to software and devices, and more specifically, to systems and methods for providing an enhanced keypad. Specific details of certain embodiments of the invention are set forth in the following description and in FIGS. 1-11 to provide a thorough understanding of such embodiments. The present invention may have additional embodiments, may be practiced without one or more of the details described for any particular described embodiment, or may have any detail described for one particular embodiment practiced with any other detail described for another embodiment.

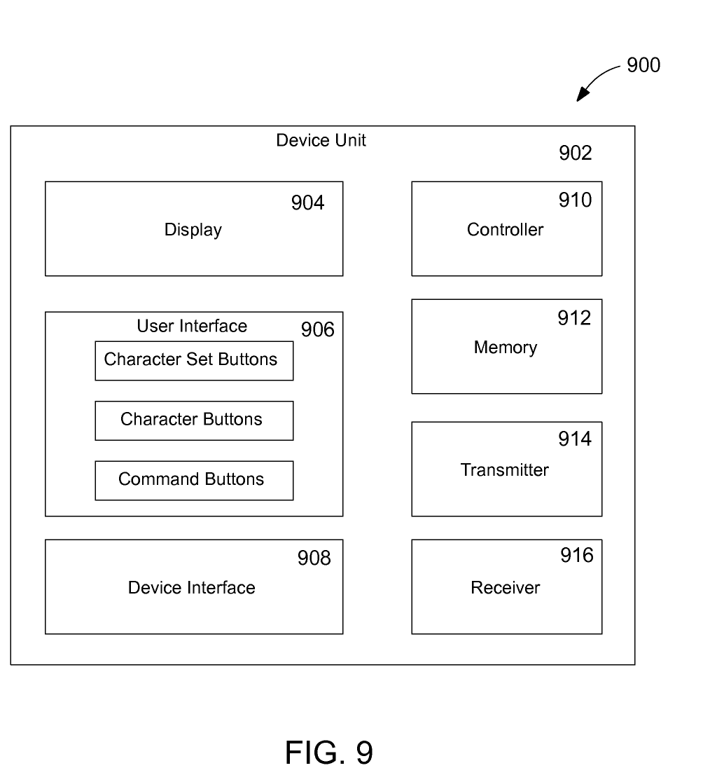

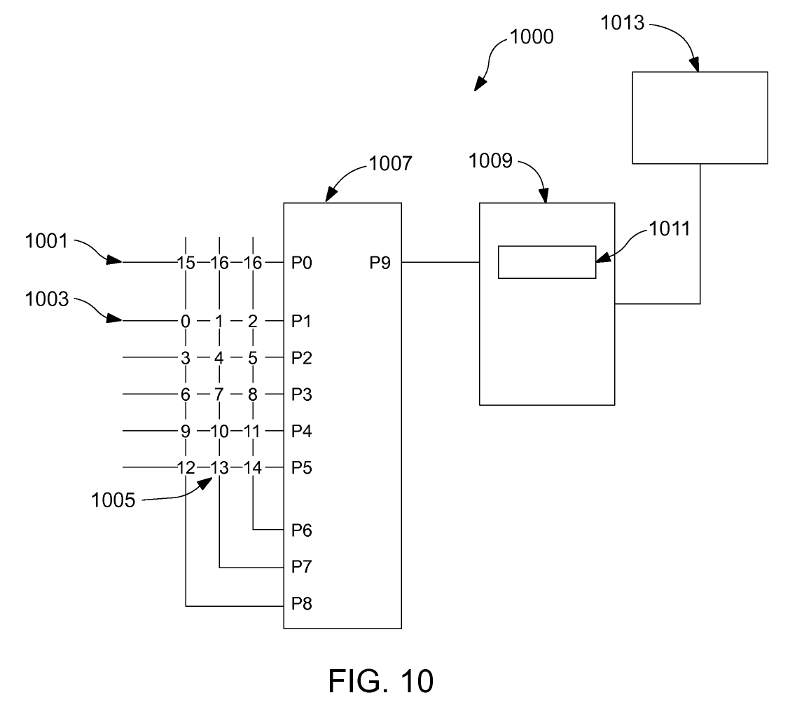

FIG. 1 is a block diagram of a method, in accordance with an embodiment of the invention. In some embodiments, method 100 may include one or more operations of establishing a character set at block 102; receiving an input selection at block 104; determining whether the input selection is a character set selection at block 106 and, if so, establishing a character set at block 102; determining whether the input selection is a command selection at block 108 and, if so, implementing a command at block 110; determining whether the input selection is a character selection at block 112 and, if so, identifying a character of the character selection at block 114. Method 100 may be repeated. Operations of method 100 may be performed by and/or in coordination with various components of device 900 (FIG. 9) and/or using circuitry 1000 (FIG. 10). For example, a character set of {a, b, c, d, e, f, g, h, i, j, k, l, m} may be initially established by assigning characters of the character set to twelve character buttons. These characters of the character set remain assigned to the twelve character buttons until a different character set is established. Input selection of the character buttons is then usable to spell letters of a word or phrase on a display, such as the first four letters of ‘hello’ (i.e. h-e-l-l). Because the character ‘o’ is not within the established character set, to complete the word hello, input selection of character set button for n-z can establish a character set of {n, o, p, q, r, s, t, u, v, w, x, y, z} by assigning characters of the character set to the same twelve character buttons. Thereafter, input selection of the character buttons is then usable to complete the word hello through input selection of the character button assigned with the character ‘o’. Additional words or phrases may similarly be spelled through appropriate input selection of character sets and character buttons as desired.

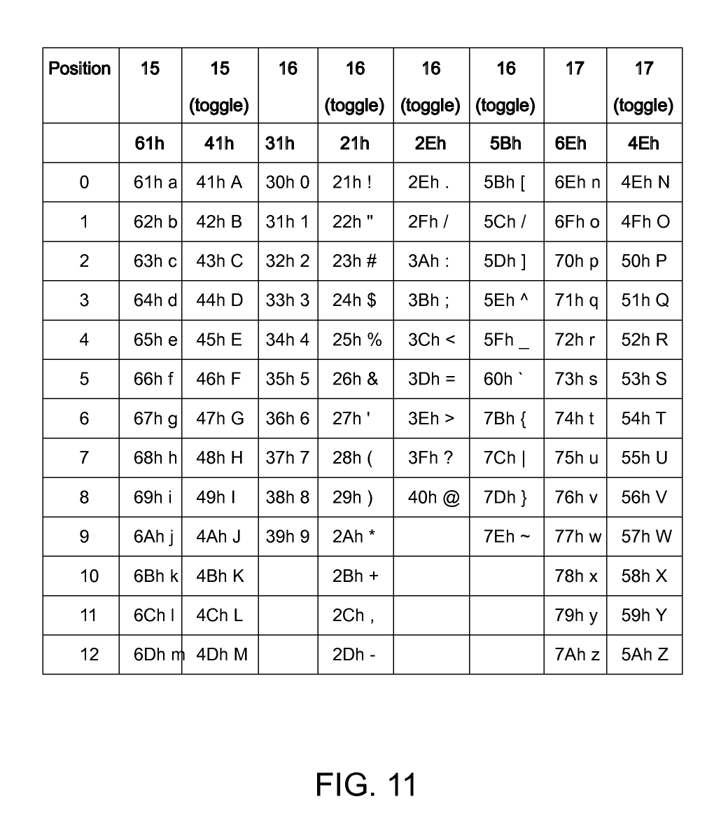

In some embodiments, method 100 may include operations of establishing a character set by assigning characters of the character set to character buttons configured to being reassigned different characters for a different character set; receiving one or more input selections; determining whether the one or more input selections is from a character button; and if the one or more input selections is from a character button, identifying a character assigned to the character button. For example, with reference to FIG. 9, controller 910 may establish a character set by assigning characters of the character set to character buttons of user interface 906, which character buttons are configured to being reassigned different characters for a different character set. Controller 910 may receive one or more input selections from character set buttons, character buttons, and/or command buttons of user interface 906. Controller 910 may determine whether the one or more input selections is from a character button of user 100 interface 906 and, if the one or more input selections is from a character button, controller 910 may identify a character assigned to the character button of user interface 906 and, optionally, display the character on display 904. Additionally, operations of method 100 may be implemented by one or more program instructions embodied in computer readable media, such as memory 912. As another example, with reference to FIG. 10, microcontroller 1009 may establish a character set by assigning characters of the character set to character buttons 1003, which character buttons are configured to being reassigned different characters for a different character set. Scan controller 1007 may receive one or more input selections from character set buttons 1001, character buttons 1003, and/or command buttons 1005. Microcontroller 1009 may determine whether the one or more input selections is from a character button 1003 and, if the one or more input selections is from a character button 1003, microcontroller 1009 may identify a character assigned to the character button 1003 and, optionally, display the character on display 1013. Alternatively, microcontroller 1009 may determine whether the one or more input selections is from a character set button 1001 and, if the one or more input selections is from a character set button 1001, microcontroller 1009 may establish the character set by assigning characters of the character set to character buttons 1003. Additionally, microcontroller 1009 may determine whether the one or more input selections is from a command button 1005 and, if the one or more input selections is from a command button 1005, microcontroller 1009 may implement the command. As a specific example, character set buttons 1001 are at positions 15-17. Character buttons 1003 are at positions 0-12. Command buttons 1005 are at positions 13-14. Upon receiving an input selection, the scan controller 1007 receives the position using ports P0-P8 and forwards the same via port P9 to the microcontroller 1009 having a register 1011. The microcontroller 1009 may associate the position with a value, such as that illustrated in FIG. 11. If the input selection is a character set selection, the microcontroller 1009 may store the value in the register 1011. If the input selection is a character selection, the microcontroller may identify the character value by combining the value of the input selection with the value stored in the register 1011. For instance, if position 15 is selected, the value 61h may be stored in the register 1011. Thereafter, if position 6 is selected, the value 6h may be combined with the value 61h stored in the register 1011 to identify the character value 67h or “g” (e.g, 67h is the ASCII code for “g”). Thereafter, if position 15 is selected again, the value 41h may be stored in the register 1011 thereby replacing the value 61h previously stored in the register 1011. Thereafter, if position 6 is selected again, the value 6h may be combined with the value 41h stored in the register 1011 to identify the character value 47h or “G” (e.g., 47h is the ASCII code for “G”). The identified character value may be stored in memory and/or output to the display 1013. Accordingly, establishing a character set by assigning characters of the character set to character buttons, as discussed in various embodiments herein, may include directly assigning character values to the character buttons or indirectly assigning character values to the character buttons by modifying a registry value without necessarily directly changing the values of the character buttons.

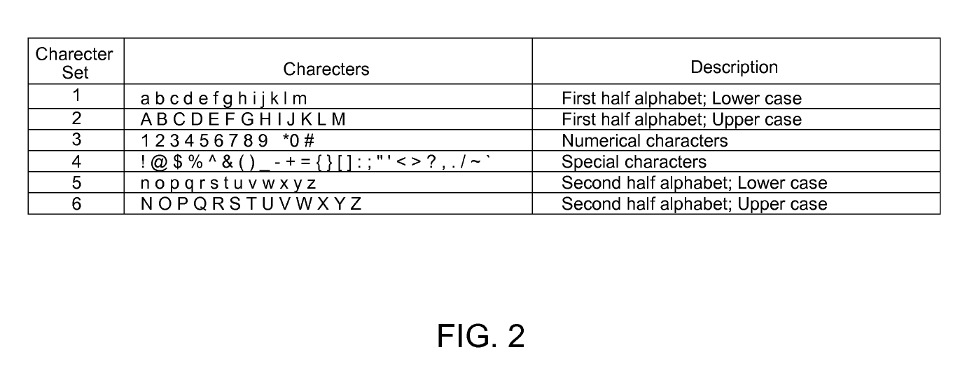

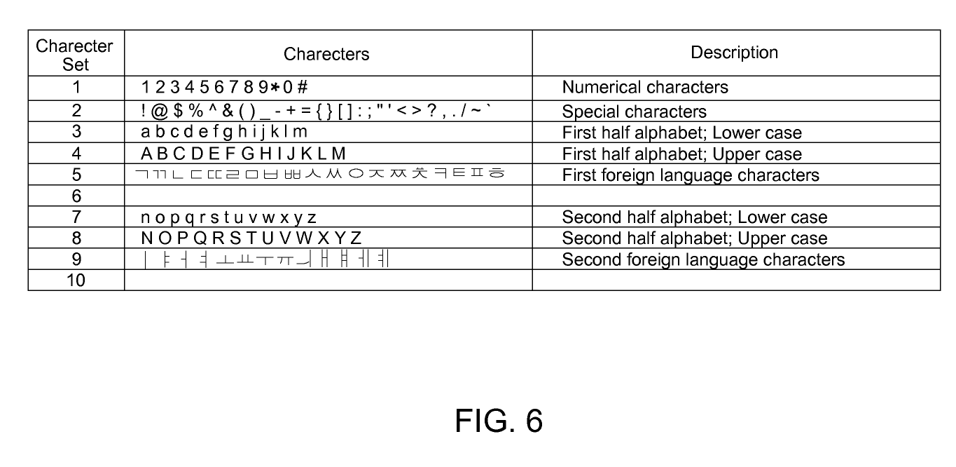

In some embodiments, the establishing a character set by assigning characters of the character set to character buttons configured to being reassigned different characters for a different character set may include establishing a character set by assigning characters of the character set to character buttons configured to being reassigned different characters for a different character set, wherein character sets are available for a first half of the alphabet in lower case, a first half of the alphabet in upper case, numbers, special characters, a second half of the alphabet in lower case, and a second half of the alphabet in upper case. For example, character sets may be available for (1) {a, b, c, d, e, f, g, h, j, k, l, m}; (2) {A, B, C, D, E, F, G, H, I, J, K, L, M}; (3) {1, 2, 3, 4, 5, 6, 7, 8, 9, *, 0, #}; (4) {!, @, $, %, ̂, &, (,), _, −, +, =, {,}, [,], :, ;, “, ‘, <, >, ?, ,, ., /, ˜, ′}; (5) {n, o, p, q, r, s, t, u, v, w, x, y, z}; and (6) {N, O, P, Q, R, S, T, U, V, W, X, Y, Z} (FIG. 2). Many other character sets may be available, including fewer or greater numbers of characters within character sets, fewer or greater character sets, character sets including foreign language characters, and character sets including symbols (FIG. 6). Character sets may be modifiable and/or customizable. In some embodiments, a currently assigned character set is displayed.

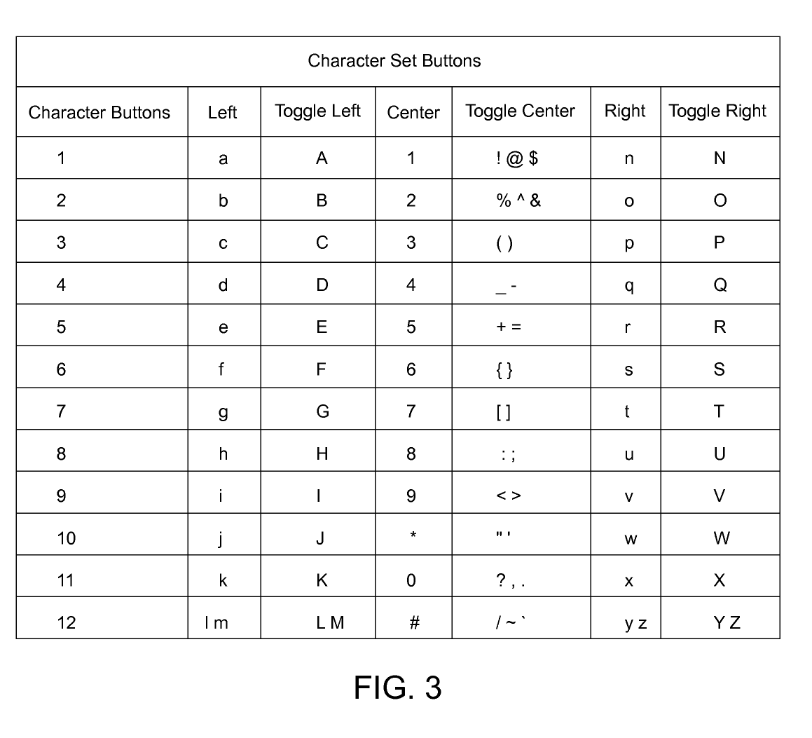

In some embodiments, the establishing a character set by assigning characters of the character set to character buttons configured to being reassigned different characters for a different character set may include establishing a character set by assigning characters of the character set to at least some toggleable character buttons configured to being reassigned different characters for a different character set. For example, characters of the character set {a, b, c, d, e, f, g, h, i, j, k, l, m} may be assigned to twelve character buttons with each character assigned to a unique character button with the exception of characters l and m, which may be assigned to the same character button being toggleable between the l and m characters. Other examples of assigning characters of characters sets to toggleable character buttons are illustrated in FIG. 3, with character buttons one through twelve being in certain circumstances assigned multiple characters.

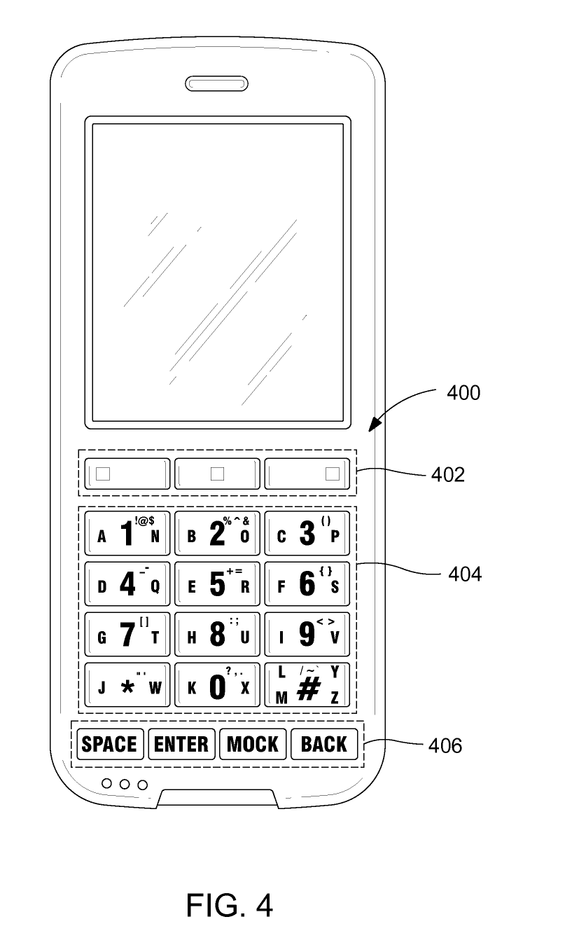

In some embodiments, the establishing a character set by assigning characters of the character set to character buttons configured to being reassigned different characters for a different character set may include establishing a character set by assigning characters of the character set to physical character buttons configured to being reassigned different characters for a different character set. For example, characters of the character set {A, B, C, D, E, F, G, H, I, J, K, L, M} may be assigned to twelve physical character buttons as illustrated in FIG. 4 with each character assigned to a unique character button with the exception of characters L and M. Similarly, characters of the character sets {1, 2, 3, 4, 5, 6, 7, 8, 9, *, 0, #}; and {!, @, $, %, ̂, &, (,), _, −, +, =, {,}, [,], :, ;, “, ’, <, >, ?, ,, ., /, ˜, ′} may be assigned to twelve physical character buttons as illustrated in FIG. 4. Also, characters of the character set {N, O, P, Q, R, S, T, U, V, W, X, Y, Z} may be assigned to twelve physical character buttons as illustrated in FIG. 4 with each character assigned to a unique character button with the exception of Y and Z. Characters of the character set may be assigned to physical character buttons of a QWERTY keypad; a traditional twelve button phone keypad as illustrated in FIG. 4; or any other keypad having any number of keys in any arrangement.

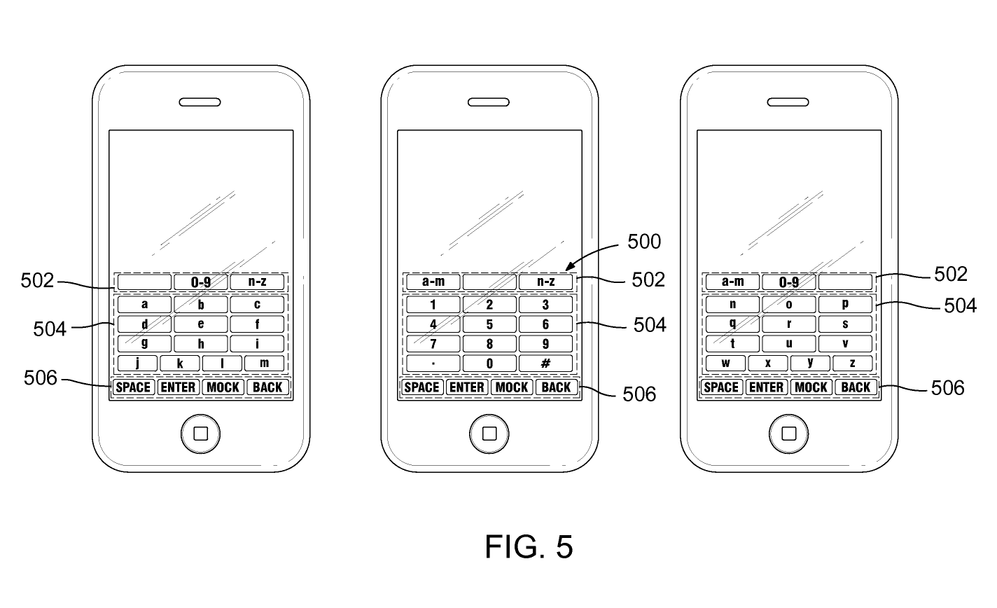

In some embodiments, the establishing a character set by assigning characters of the character set to character buttons configured to being reassigned different characters for a different character set may include establishing a character set by assigning characters of the character set to electronic character buttons of configured 190 to being reassigned different characters for a different character set. For example, characters of the character set {a, b, c, d, e, f, g, h, i, j, k, l, m} may be assigned to thirteen electronic character buttons as illustrated in FIG. 5 with each character assigned to a unique character button. Similarly, characters of the character set {1, 2, 3, 4, 5, 6, 7, 8, 9, *, 0, #} may be assigned to twelve electronic character buttons as illustrated in FIG. 5. Also, characters of the character set {n, o, p, q, r, s, t, u, v, w, x, y, z} may be assigned to thirteen character buttons as illustrated in FIG. 5 with each character assigned to a unique character button. Characters of the character set may be assigned to fewer or greater numbers of electronic character buttons in any arrangement. The number of electronic character buttons and their arrangement may be modifiable and/or customizable.

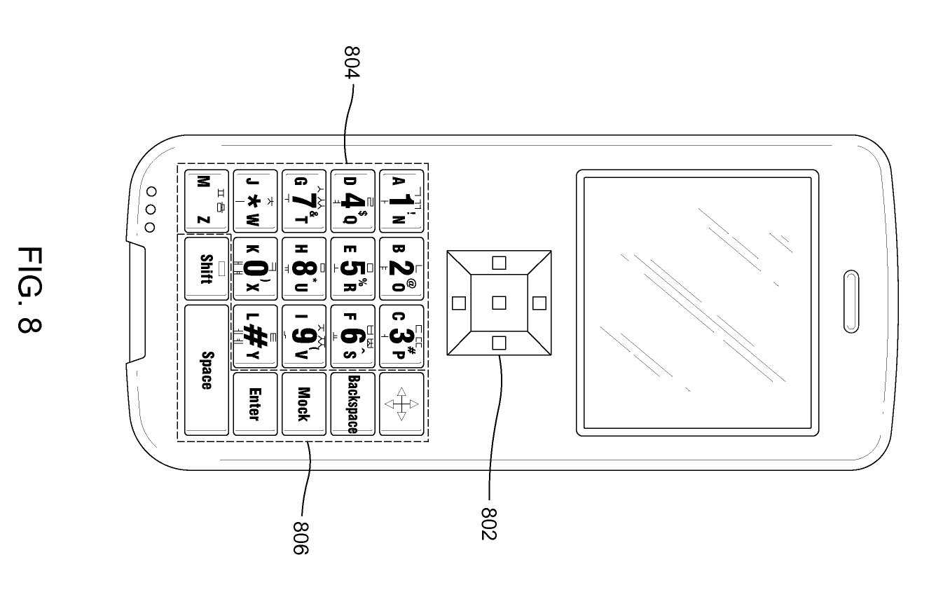

In some embodiments, the establishing a character set by assigning characters of the character set to character buttons configured to being reassigned different characters for a different character set may include establishing a character set by assigning characters of the character set to character buttons configured to being reassigned different characters for a different character set, wherein the character buttons include a visual representation of potential characters. For example, character buttons may include a visual representation of potential characters for the character buttons, which assigned characters of the character buttons depend upon which character set has been established. As illustrated in FIG. 4, character buttons may include the following visual representations of potential characters: (1) A 1^{!@$} N; (2) B 2^{%̂&} O; (3) C 3^{( )} P; (4) D 4-⁻ Q; (5) E 5⁺⁼ R; (6) F 6^{{ }} S; (7) G 7^{[ ]} T; (8) H 8^{:;} U; (9) I 9^{< >} V; (10) J *^{“ ”} W; (11) K 0^{?,.} X; and (12) LM #^{/˜′} YZ. Character buttons may include fewer or greater visual representations of potential characters as illustrated in FIG. 8.

In some embodiments, the establishing a character set by assigning characters of the character set to character buttons configured to being reassigned different characters for a different character set may include establishing a character set by assigning characters of the character set to character buttons configured to being reassigned different characters for a different character set, wherein the character buttons include a visual representation of potential characters with assigned characters being illuminated. For example, character buttons may include a visual representation of potential characters for the character buttons with assigned characters of the character button illuminated based upon which character set has been established. Character buttons may include the following visual representations of potential characters: (1) A 1 N; (2) B 2 O; (3) C 3 P; (4) D 4 Q; (5) E 5 R; (6) F 6 S; (7) G 7 T; (8) H 8 U; (9) I 9 V; (10) J * W; (11) K 0 X; and (12) LM # YZ. Visual representations of potential characters A, B, C, D, E, F, G, H, I, J, K, LM may be illuminated when character set {A, B, C, D, E, F, G, H, I, J, K, L,M} has been established. Visual representations of potential characters 1, 2, 3, 4, 5, 6, 7, 8, 9, *, 0, # may be illuminated when character set {1, 2, 3, 4, 5, 6, 7, 8, 9, *, 0, #} has been established. Visual representations of potential characters N, O, P, Q, R, S, T, U, V, W, X, YZ may be illuminated when character set {N, O, P, Q, R, S, T, U, V, W, X, Y, Z} has been established. Assigned characters may be differently indicated, such as using a display, an underline, a color change, or using some other similar methodology.

In some embodiments, the establishing a character set by assigning characters of the character set to character buttons configured to being reassigned different characters for a different character set may include establishing a character set by assigning characters of the character set to electronic character buttons configured to being reassigned different characters for a different character set, wherein the character buttons include a visual representation limited to assigned characters. For example, character buttons may include a visual representation of limited to assigned characters of the character button based upon which character set has been established. As illustrated in FIG. 5, character buttons may include visual representations of assigned characters a, b, c, d, e, f, g, h, i, j, k, l, m when character set {a, b, c, d, e, f, g, h, i, j, k, l, m} has been established. Character buttons may include visual representations of assigned characters 1, 2, 3, 4, 5, 6, 7, 8, 9, *, 0, # when character set {1, 2, 3, 4, 5, 6, 7, 8, 9, *, 0, #} has been established. Character buttons may include visual representations of assigned characters n, o, p, q, r, s, t, u, v, w, x, y, z when character set {n, o, p, q, r, s, t, u, v, w, x, y, z} has been established.

In some embodiments, method 100 may include operations of determining whether the one or more input selections is from a character set button; and if the one or more input selections is from a character set button, establishing a character set corresponding to the character set button by assigning characters of the character set to the character buttons configured to being reassigned different characters for a different character set. For example, controller 910 may determine whether the one or more input 255 selections is from a character set button of user interface 906. Controller 910 may establish a character set corresponding to the character set button by assigning characters of the character set to the character buttons of user interface 906 configured to being reassigned different characters for a different character set. Additionally, operations of method 100 may be implemented by one or more program instructions embodied in computer readable media, such as memory 912.

In some embodiments, the determining whether the one or more input selections is from a character set button may include determining whether the one or more input selections is from a character set button, wherein character set buttons are provided for character sets including a first half of the alphabet in lower case, a first half of the alphabet in upper case, numbers, and special characters, a second half of the alphabet in lower case, and a second half of the alphabet in upper case. For example, a first character set button may be provided for character set {a, b, c, d, e, f, g, h, i, j, k, l, m}; a second character set button may be provided for character set {A, B, C, D, E, F, G, H, I, J, K, L, M}; a third character set button may be provided for character set {1, 2, 3, 4, 5, 6, 7, 8, 9, *, 0, #}; a fourth character set button may be provided for character set {!, @, $, %, ̂, &, (,), _, −, +, =, {,}, [,], :, ;, “, ‘, >, ?, ,, ., /, ˜, ′}; a fifth character set button may be provided for character set {n, o, p, q, r, s, t, u, v, w, x, y, z}; and a sixth character set button may be provided for character set {N, O, P, Q, R, S, T, U, V, W, X, Y, Z}. Fewer or greater numbers of character set buttons may be provided, which buttons may be modifiable and/or customizable. Character set buttons may be arranged as separate buttons as illustrated in FIG. 4 and FIG. 5 or as a combined button as illustrated in FIG. 8. Also, as illustrated in FIG. 8, character set buttons may be provided in association with a shift command button, which may be used to toggle between different character sets.

In some embodiments, the determining whether the one or more input selections is from a character set button may include determining whether the one or more input selections is from a character set button, wherein a first toggleable character set button is provided for a first half of the alphabet in lower case and a first half of the alphabet in upper case, and a second toggleable character set button is provided for numbers and special characters, and a third toggleable character set button is provided for a second half of the alphabet in lower case and a second half of the alphabet in upper case. For example, a first character set button may be provided for character sets {a, b, c, d, e, f, g, h, i, j, k, l, m} and {A, B, C, D, E, F, G, H, I, J, K, L, M}; a second character set button may be provided for character sets {1, 2, 3, 4, 5, 6, 7, 8, 9, *, 0, #} and {!, @, $, %, ̂, &, (,), _, −, +, =, {,}, [,], :, ;, “, ’, <, >, ?, ,, ., /, ˜, ′}; and a third character set button may be provided for character sets {n, o, p, q, r, s, t, u, v, w, x, y, z} and {N, O, P, Q, R, S, T, U, V, W, X, Y, Z}. The first, second, and third character set buttons may each be toggleable between corresponding character sets. Fewer or greater numbers of toggleable character set buttons may be provided with each character set button being provided with fewer or greater numbers of character sets, any of which may be modifiable and/or customizable.

In some embodiments, the determining whether the one or more input selections is from a character set button may include determining whether the one or more input selections is from a physical character set button. For example, one or more input selections may be from three separate physical character set buttons as illustrated in FIG. 4. One or more input selections may be from a combined physical character set button as illustrated in FIG. 8. Fewer or greater numbers of physical character set buttons may be provided and physical character set buttons may be arranged in any manner, any of which may be modifiable and/or customizable.

In some embodiments, the determining whether the one or more input selections is from a character set button may include determining whether the one or more input selections is from an electronic character set button. For example, one or more input selections may be from three separate electronic character set buttons as illustrated in FIG. 5. Fewer or greater numbers of electronic character set buttons may be provided and electronic character set buttons may be arranged in any manner, any of which may be modifiable and/or customizable. Input selections of character sets may be automated through probabilities based upon most likely intended words.

In some embodiments, the determining whether the one or more input selections is from a character set button may include determining whether the one or more input selections is from a character set button, wherein character set buttons include a visual representation of potential character sets. For example, as illustrated in FIG. 5, a first character set button may include a-m for character set {a, b, c, d, e, f, g, h, i, j, k, l, m}; a second character set button may include 0-9 for character set {1, 2, 3, 4, 5, 6, 7, 8, 9, *, 0, #}; and a third character set button may include n-z for character set {n, o, p, q, r, s, t, u, v, w, x, y, z}. As illustrated in FIG. 4 and FIG. 8, a first character set button may include a left position indicator for character set {A, B, C, D, E, F, G, H, I, J, K, L, M}; a center position indicator for character set {1, 2, 3, 4, 5, 6, 7, 8, 9, *, 0, #}; and a right position indicator for character set {N, O, P, Q, R, S, T, U, V, W, X, Y, Z}. Character set buttons may include a visual representation of one potential character set, with another potential character set being implied, such as a-m also implying character set {A, B, C, D, E, F, G, H, I, J, K, L, M}.

In some embodiments, the determining whether the one or more input selections is from a character set button may include determining whether the one or more input selections is from a character set button, wherein character set buttons include a visual representation of potential character sets with a current character set being illuminated. For example, character set buttons may include the following visual representations of potential character sets: (1) a-m; (2) 0-9; and (3) n-z. Visual representation of potential character set a-m may be illuminated when character set {a, b, c, d, e, f, g, h, i, j, k, l, m} has been established. Visual representation of potential 335 character set 0-9 may be illuminated when character set {1, 2, 3, 4, 5, 6, 7, 8, 9, *, 0, #} has been established. Visual representation of potential character set n-z may be illuminated when character set {n, o, p, q, r, s, t, u, v, w, x, y, z} has been established. Current character set may be differently indicated, such as using a display, an underline, a color change, a size difference, or using some other similar methodology.

In some embodiments, method 100 may include operations of determining whether the one or more input selections is from a command button; and if the one or more input selections is from a command button, implementing a command corresponding to the command button. For example, controller 910 may determine whether the one or more input selections is from a command button of user interface 906 and, if the one or more input selections is from a command button of user interface 906, controller 910 may implement a command corresponding to the command button.

In some embodiments, the determining whether the one or more input selections is from a command button may include determining whether the one or more input selections is from a command button, wherein command buttons are provided for space, enter, mock, and back. For example, a space command button may be provided to create a space character and/or move a cursor; an enter command button may be provided to create an enter/return character and/or move a cursor; and a back command button may be provided to remove a character and/or move a cursor. A mock command button may be provided to create a placeholder character within a word to avoid switching to a different character set. The placeholder character may be resolved automatically and/or with user input based upon other selected characters. For example, a character set of {a, b, c, d, e, f, g, h, i, j, k, l, m} may be initially established by assigning characters of the character set to twelve character buttons. These characters of the character set remain assigned to the twelve character buttons until a different character set is established. Input selection of the character buttons is then usable to spell letters of a word or phrase on a display, such as the word ‘dog’, with a mock command button selected for ‘o’ (i.e. d- -g). The mock command placeholder character may then be resolved to dog without requiring switching to a character set including character ‘o’. A shift command button may be provided to shift between upper and lower case or potential characters of a character button, such as without requiring establishing an entire character set for merely a single character. Fewer or greater numbers of command buttons may be provided having fewer or greater functions, any of which may be modified and/or customized.

In some embodiments, the determining whether the one or more input selections is from a command button may include determining whether the one or more input selections is from a physical command button. For example, one or more input selections may be from four separate physical command buttons as illustrated in FIG. 4. Fewer or greater numbers of physical command buttons may be provided and physical command buttons may be arranged in any manner, any of which may be modifiable and/or customizable.

In some embodiments, the determining whether the one or more input selections is from a command button may include determining whether the one or more input selections is from an electronic command button. For example, one or more input selections may be from four separate electronic command buttons as illustrated in FIG. 5. Fewer or greater numbers of electronic command buttons may be provided and electronic command buttons may be arranged in any manner, any of which may be modifiable and/or customizable.

FIGS. 4, 5, and 8 are a device interfaces, in accordance with various embodiments of the invention. In some embodiments, device interface 400 includes physical character set buttons 402, character buttons 404, and command buttons 406. In some embodiments, device interface 500 includes electronic character set buttons 502, character buttons 504, and command buttons 506. In some embodiments, device interface 800 includes a combined character set button 802, character buttons 804, and command buttons 806. Device interfaces 400, 500, and 800 may be implemented on a mobile phone, internet appliance, personal digital assistant, computer, or any other similar device.

FIG. 9 is a component diagram of a device, in accordance with an embodiment of the invention. In some embodiments, device 900 may include device 902, display 904, user interface 906 including character set buttons, character buttons, and/or command buttons, device interface 908, controller 910, memory 912, transmitter 914, and receiver 916. Device 900 may include any mobile phone, internet appliance, personal digital assistant, computer, or any other similar device. Display 904 may include any display configured to present visually perceptible information, such as an LCD screen. User interface 906 may include physical, electronic, and/or a combination of physical and electronic interface components. Device interface 908 may include any components configurable to enable communication with one or more additional devices. Controller 910 may include any processor having programmable instructions and memory. Memory 912 may include any volatile or non-volatile memory. Transmitter 914 and receiver 916 may include any components configured to enable wired or wireless communication. Device 900 may perform one or more operations of method 100.

FIG. 10 is a circuit diagram, in accordance with an embodiment of the invention. In some embodiments, circuitry 1000 may include one or more character set buttons 1001, one or more character buttons 1003, one or more command buttons 1005, one or more scan controllers 1007, one or more microcontrollers 1009 having one or more registers 1011, and one or more displays 1013. Circuitry 1000 may perform one or more operations of method 100.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A method comprising:
establishing a character set by assigning characters of the character set to character buttons configured to being reassigned different characters for a different character set;
receiving one or more input selections;
determining whether the one or more input selections is from a character button; and
if the one or more input selections is from a character button, identifying a character assigned to the character button.

2. The method of claim 1, wherein the establishing a character set by assigning characters of the character set to character buttons configured to being reassigned different characters for a different character set comprises:
establishing a character set by assigning characters of the character set to character buttons configured to being reassigned different characters for a different character set, wherein character sets are available for a first half of the alphabet in lower case, a first half of the alphabet in upper case, numbers, special characters, a second half of the alphabet in lower case, and a second half of the alphabet in upper case.

3. The method of claim 1, wherein the establishing a character set by assigning characters of the character set to character buttons configured to being reassigned different characters for a different character set comprises:
establishing a character set by assigning characters of the character set to at least some toggleable character buttons configured to being reassigned different characters for a different character set.

4. The method of claim 1, wherein the establishing a character set by assigning characters of the character set to character buttons configured to being reassigned different characters for a different character set comprises:
establishing a character set by assigning characters of the character set to physical character buttons configured to being reassigned different characters for a different character set.

5. The method of claim 1, wherein the establishing a character set by assigning characters of the character set to character buttons configured to being reassigned different characters for a different character set comprises:
establishing a character set by assigning characters of the character set to electronic character buttons of configured to being reassigned different characters for a different character set.

6. The method of claim 1, wherein the establishing a character set by assigning characters of the character set to character buttons configured to being reassigned different characters for a different character set comprises:
establishing a character set by assigning characters of the character set to character buttons configured to being reassigned different characters for a different character set, wherein the character buttons include a visual representation of potential characters.

7. The method of claim 1, wherein the establishing a character set by assigning characters of the character set to character buttons configured to being reassigned different characters for a different character set comprises:
establishing a character set by assigning characters of the character set to character buttons configured to being reassigned different characters for a different character set, wherein the character buttons include a visual representation of potential characters with assigned characters being illuminated.

8. The method of claim 1, wherein the establishing a character set by assigning characters of the character set to character buttons configured to being reassigned different characters for a different character set comprises:
establishing a character set by assigning characters of the character set to electronic character buttons configured to being reassigned different characters for a different character set, wherein the character buttons include a visual representation limited to assigned characters.

9. The method of claim 1, further comprising:
determining whether the one or more input selections is from a character set button; and
if the one or more input selections is from a character set button, establishing a character set corresponding to the character set button by assigning characters of the character set to the character buttons configured to being reassigned different characters for a different character set.

10. The method of claim 9, wherein the determining whether the one or more input selections is from a character set button comprises:
determining whether the one or more input selections is from a character set button, wherein character set buttons are provided for character sets including a first half of the alphabet in lower case, a first half of the alphabet in upper case, numbers, and special characters, a second half of the alphabet in lower case, and a second half of the alphabet in upper case.

11. The method of claim 9, wherein the determining whether the one or more input selections is from a character set button comprises:
determining whether the one or more input selections is from a character set button, wherein a first toggleable character set button is provided for a first half of the alphabet in lower case and a first half of the alphabet in upper case, and a second toggleable character set button is provided for numbers and special characters, and a third toggleable character set button is provided for a second half of the alphabet in lower case and a second half of the alphabet in upper case.

12. The method of claim 9, wherein the determining whether the one or more input selections is from a character set button comprises:
determining whether the one or more input selections is from a physical character set button.

13. The method of claim 9, wherein the determining whether the one or more input selections is from a character set button comprises:
determining whether the one or more input selections is from an electronic character set button.

14. The method of claim 9, wherein the determining whether the one or more input selections is from a character set button comprises:
determining whether the one or more input selections is from a character set button, wherein character set buttons include a visual representation of potential character sets.

15. The method of claim 9, wherein the determining whether the one or more input selections is from a character set button comprises:
determining whether the one or more input selections is from a character set button, wherein character set buttons include a visual representation of potential character sets with a current character set being illuminated.

16. The method of claim 1, further comprising:
determining whether the one or more input selections is from a command button; and
if the one or more input selections is from a command button, implementing a command corresponding to the command button.

17. The method of claim 16, wherein the determining whether the one or more input selections is from a command button comprises:
determining whether the one or more input selections is from a command button, wherein command buttons are provided for space, enter, mock, and back.

18. The method of claim 16, wherein the determining whether the one or more input selections is from a command button comprises:
determining whether the one or more input selections is from a physical command button.

19. The method of claim 16, wherein the determining whether the one or more input selections is from a command button comprises:
determining whether the one or more input selections is from an electronic command button.

20. A device comprising:
a display;
a user interface including character buttons; and
a controller configured for performing operations of
establishing a character set by assigning characters of the character set to the character buttons configured to being reassigned different characters for a different character set;
receiving one or more input selections from the user interface;
determining whether the one or more input selections is from a character button;
if the one or more input selections is from a character button, identifying a character assigned to the character button and displaying the character on the display.
